(19) United States
(12) Patent Application Publication
(10) Pub. No.: US 2026/0254356 A1
(43) Pub. Date: Aug. 27, 2026

(54) SWITCHING CONVERTER MODE TRANSITION CONTROL

(71) Applicant: TEXAS INSTRUMENTS INCORPORATED, Dallas, TX (US)

(72) Inventors: Chuansong PANG, Shanghai (CN); Chaofan DU, Wuxi (CN); Yueming SUN, Shanghai (CN); Yuqing WU, Shanghai (CN)

(21) Appl. No.: 19/061,862

(22) Filed: Feb. 24, 2025

(51) Int. Cl. H02M 3/155; H02M 1/00

(52) U.S. Cl. CPC H02M 3/155; H02M 1/0025

(57) ABSTRACT

A circuit includes first, second, third, and fourth transistors, first, second, and third current sources, an amplifier, and a voltage-to-current converter (V2I). The second transistor is coupled between the first transistor and the third transistor. The third transistor is coupled between the second transistor and a first input of the V2I. The fourth transistor is coupled between the first transistor and a second input of the V2I. The amplifier has a first input coupled to a reference voltage terminal, and a second input coupled to the first transistor. The V2I has a third input coupled to an output of the amplifier, a fourth input coupled to the second current source, and a fifth input coupled to the third current source. The first current source is coupled between the fourth transistor and the reference terminal.

### BACKGROUND

A switching converter is an electronic circuit that converts an input direct current (DC) voltage into one or more DC output voltages that are higher or lower in magnitude than the input DC voltage. A switching converter that generates an output voltage lower than the input voltage is termed a buck or step-down converter. A switching converter that generates an output voltage higher than the input voltage is termed a boost or step-up converter. A switching converter that generates an output that is either higher or lower than the input voltage is termed a buck-boost converter. Switching converters are widely used to power electronic devices, particularly battery powered devices, such as portable cellular phones, laptop computers, and other electronic systems in which efficient use of power is desirable.

### SUMMARY

In one example, a circuit includes a first, second, third, and fourth transistors, first, second, and third current sources, an amplifier, and a voltage-to-current converter. The first transistor has a first terminal, a second terminal, and a control terminal. The second transistor has a first terminal coupled to the first terminal of the first transistor, a second terminal, and a control terminal coupled to the control terminal of the first transistor. The third transistor has a first terminal coupled to the second terminal of the second transistor, a second terminal, and a control terminal. The fourth transistor has a first terminal coupled to the second terminal of the first transistor, a second terminal, and a control terminal coupled to the control terminal of the third transistor. The amplifier has a first input coupled to a reference voltage terminal, a second input coupled to the second terminal of the first transistor, and an output. The voltage-to-current converter has a first input coupled to the second terminal of the third transistor, a second input coupled to the second terminal of the fourth transistor, a third terminal coupled to the output of the amplifier, a fourth input, and a fifth terminal. The first current source has an input coupled to the second terminal of the fourth transistor, and an output coupled to the reference terminal. The second current source has an input coupled to a power terminal, and an output coupled to the fourth input of the voltage-to-current converter. The third current source has an input coupled to the input of the second current source, and an output coupled to the fifth input of the voltage-to-current converter.

In another example, a circuit includes first, second, third, and fourth transistors, a first amplifier, a voltage-to-current converter, and first and second current sources. The first transistor has a first terminal, a second terminal, and a control terminal. The second transistor has a first terminal coupled to the first terminal of the first transistor, a second terminal, and a control terminal coupled to the control terminal of the first transistor. The third transistor has a first terminal coupled to the second terminal of the second transistor, a second terminal, and a control terminal. The fourth transistor has first terminal coupled to the second terminal of the first transistor, a second terminal, and a control terminal coupled to the control terminal of the third transistor. The first amplifier has a first input coupled to a reference voltage terminal, a second input coupled to the second terminal of the first transistor, and an output. The voltage-to-current converter has a first input coupled to the second terminal of the third transistor, a second input coupled to the second terminal of the fourth transistor, a third input coupled to the output of the first amplifier, a fourth input, and a fifth input. The first current source has an input coupled to a power terminal, and an output coupled to the fourth input of the voltage-to-current converter. The second current source includes fifth, sixth, seventh, and eighth transistors, a third current source, and a second amplifier. The fifth transistor has a first terminal coupled to a power terminal, a second terminal, and a control terminal coupled to a reference terminal. The sixth transistor has a first terminal coupled to the power terminal, a second terminal, and a control terminal coupled to the reference terminal. The third current source has an input coupled to the second terminal of the fifth transistor, and an output coupled to a reference terminal. The amplifier has a first input coupled to the second terminal of the fifth transistor, a second input coupled to the second terminal of the sixth transistor, and an output. The seventh transistor has a first terminal coupled to the second terminal of the sixth transistor, a second terminal coupled to the reference terminal, and a control terminal coupled to the output of the amplifier. The eighth transistor has a first terminal coupled to the fifth input of the voltage-to-current converter, a second terminal coupled to the reference terminal, and a control terminal coupled to the control terminal of the seventh transistor.

In a further example, a system includes a switching converter. The switching converter includes a low-side transistor, a high-side transistor, a sense transistor, a voltage to current transistor, a first transistor, a second transistor, a comparator, an error amplifier, a controller, and an offset current source. The low-side transistor has a first terminal coupled to a voltage terminal, a second terminal coupled to a reference terminal, and a control terminal. The high-side transistor has a first terminal coupled to the voltage terminal, a second terminal, and a control terminal. The sense transistor has a first terminal coupled to the first terminal of the high-side transistor, a second terminal, and a control terminal coupled to the control terminal of the high-side transistor. The sense transistor is configured to conduct a sense current representative of a current flowing through the high-side transistor. The voltage-to-current converter has first, second, third, fourth, and fifth inputs. The first transistor is coupled between the second terminal of the sense transistor and the first input of the voltage-to-current converter. The first transistor is configured to conduct the sense current. The second transistor is coupled between the second terminal of the high-side transistor and the second input of the voltage-to-current converter. The comparator has a first input coupled to the second terminal of the first transistor, a second input coupled to the second terminal of the second transistor, and an output. The error amplifier has a first input coupled to the second terminal of the high-side transistor, a second input coupled to a reference voltage terminal, and an output coupled to the third input of the voltage-to-current converter. The controller has a first output coupled to the control terminal of the low-side transistor, a second output coupled to the control terminal of the high-side transistor, and an input coupled to the output of the comparator. The controller is configured to drive the high-side transistor in a first mode and a second mode. The current source is coupled between the second terminal of the second transistor and the reference terminal. The current source is configured to draw a current from the second transistor in the first mode and the second mode.

### BRIEF DESCRIPTION OF THE DRAWINGS

FIG. 1 is a schematic diagram of an example switching converter with reduced output transients when changing modulation modes.

FIG. 2 is a schematic diagram of an example of a first clamp compensation current source suitable for use in the switching converter of FIG. 1.

FIG. 3 is a schematic diagram of an example of a second clamp compensation current source suitable for use in the switching converter of FIG. 1.

FIG. 4 is a schematic diagram of an example of a voltage to current conversion circuit suitable for use in the switching converter of FIG. 1.

FIG. 5 is a schematic diagram of an example of a clamp current source suitable for use in the switching converter of FIG. 1.

FIG. 6 is a graph of example reference current clamping in the switching converter of FIG. 1.

FIGS. 7A and 7B are flow diagrams illustrating changes in modulation mode and operation of the switching converter of FIG. 1, in an example.

FIGS. 8 and 9 are graphs of example signals in the switching converter of FIG. 1 and a switching converter that changes current loop configuration with modulation mode changes.

FIG. 10 is a block diagram of an example ultrasonic lens cleaning system that includes the switching converter of FIG. 1.

### DETAILED DESCRIPTION

To provide efficient operation under a variety of operational conditions, some switching converters employ multiple modulation modes. For example, a switching converter may apply pulse frequency modulation (PFM) during start-up or in low load conditions, and apply forced pulse width modulation (FPWM) after start-up or in higher load conditions. In some switching converter implementations, the transition from PFM to FPWM produces a significant transient on the output voltage of the switching converter. The switching converters described herein transition between modulation modes and reduce the output voltage transients produced during the modulation mode transition.

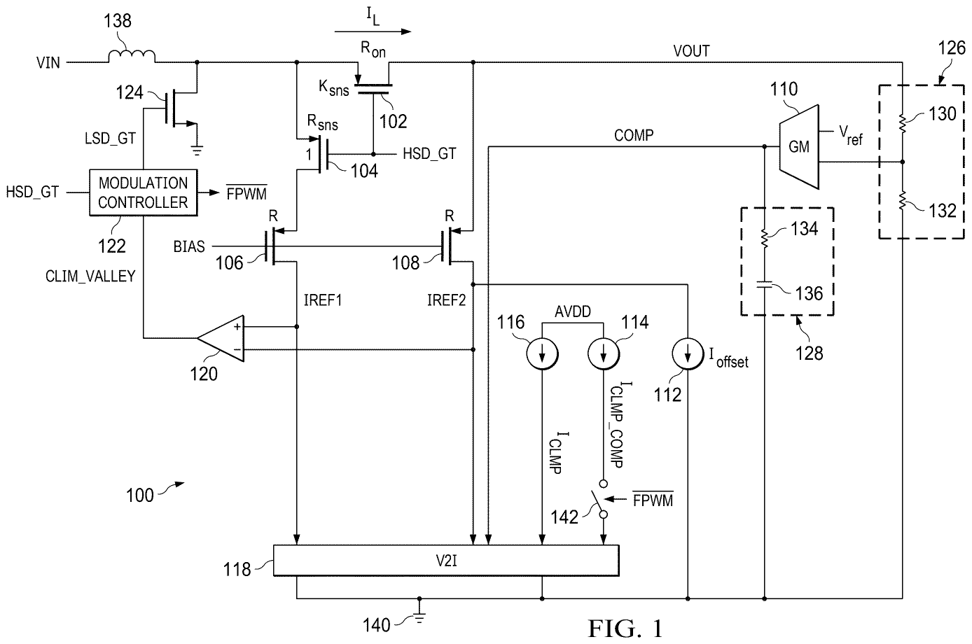

FIG. 1 is a schematic diagram of an example switching converter 100 with reduced output transients when changing modulation modes. The switching converter 100 is illustrated as a boost converter, but other examples of the switching converter 100 may be buck-boost or buck converters. The switching converter 100 includes transistors 102, 104, 106, 108, and 124, amplifier 110, a comparator 120, current sources 112, 114, and 116, a switch 142, a voltage-to-current converter 118, a modulation controller 122, a voltage divider 126, a compensation network 128, and an inductor 138. Some portions of the switching converter 100 (e.g., the transistors 102, 104, 106, 108, and 124, the amplifier 110, the comparator 120, the current sources 112, 114, and 116, the voltage-to-current converter 118, and the modulation controller 122) may be provided on an integrated circuit.

The transistor 102 and the transistor 124 may be referred to as a high-side transistor and a low-side transistor, respectively. The transistor 102 may be a p-channel metal oxide semiconductor field effect transistor (PFET), and the transistor 124 may be a n-channel metal oxide semiconductor field effect transistor (NFET). The transistor 124 has a first terminal (e.g., drain) coupled to a first terminal of the inductor 138, a second terminal (e.g., source) coupled to a reference terminal (e.g., ground 140), and a control terminal (e.g., gate) coupled to the modulation controller 122. A second terminal of the inductor 138 is coupled to an input voltage terminal (VIN). The transistor 102 has a first terminal (e.g., source) coupled to the first terminal of the transistor 124, a second terminal (e.g., drain) coupled to an output voltage terminal (VOUT), and a control terminal (e.g., gate) coupled to the modulation controller 122.

The transistor 104 may be referred to as a sense transistor. The transistor 104 may be a PFET, and may be scaled replica of the transistor 102. A first terminal (e.g., source) of the transistor 104 is coupled to the first terminal of the transistor 102, and a control terminal (e.g., gate) coupled to the control terminal of the transistor 102. A second terminal (e.g., drain) of the transistor 104 is coupled to a first terminal (e.g., source) of the transistor 106. A second terminal (e.g., drain) of the transistor 106 is coupled to the voltage-to-current converter 118, and a control terminal (e.g., gate) coupled to a bias voltage circuit (not shown). The transistor 108 has a first terminal (e.g., drain) coupled to the second terminal of the transistor 102, a second terminal (e.g., drain) coupled to the voltage-to-current converter 118, and a control terminal (e.g., gate) coupled to the control terminal of the transistor 106. The transistors 106 and 108 may be PFETs. A current IREF1 flows through the transistor 104 and the transistor 106 to the voltage-to-current converter 118, and current IREF2 flows through the transistor 108 to the voltage-to-current converter 118.

The voltage divider 126 is coupled between the second terminal of the transistor 102 and the reference terminal. The voltage divider 126 includes a resistor 130 and a resistor 132. A first terminal of the resistor 130 is coupled to the second terminal of the transistor 102, and a second terminal of the resistor 130 is coupled to a first input of the amplifier 110. The resistor 132 is coupled between the second terminal of the resistor 130 and the reference terminal. The amplifier 110 has a second input coupled to a reference voltage circuit (not shown) that provides a reference voltage (Vref), and an output coupled to the voltage-to-current converter 118. The amplifier 110 provides an error signal (COMP) representing a difference between Vref and the divided voltage at VOUT. The compensation network 128 includes a resistor 134 and a capacitor 136 coupled in series between the output of the amplifier 110 and the reference terminal.

The comparator 120 detects a valley in the current I_{L} flowing through the transistor 102 based on the signals IREF1 and IREF2. The comparator 120 compares IREF1 and IREF2, and produces an output signal CLIM_VALLEY that represents detection of a valley in I_{L}. The comparator 120 has a first input coupled to the second terminal of the transistor 106, a second input coupled to the second terminal of the transistor 108, and an output coupled to the modulation controller 122.

The modulation controller 122 controls switching of the transistor 124 and the transistor 102. The modulation controller 122 has a first output coupled to the control terminal of the transistor 102, a second output coupled to the control terminal of the transistor 124. A control signal HSD_GT is provided at the first output of the modulation controller 122 for switching the transistor 102. A control signal LSD_GT is provided at the second output of the modulation controller 122 for switching the transistor 124. The modulation controller 122 can operate the transistor 124 and the transistor 102 in PFM or FPWM in some examples. For example, the modulation controller 122 can control switching of the transistor 124 and the transistor 102 based on CLIM_VALLEY, and select PFM or FPWM operation based on load current, start-up timing, or other considerations. The modulation controller 122 has a third output at which a control signal FPWM is provided. FPWM identifies the modulation mode in which the switching converter 100 is operating. FPWM has a logic low state if the switching converter 100 is operating in FPWM, and has a logic high state if the switching converter 100 is operating in PFM. FPWM operation may require that reverse current (current flow from VOUT through the transistor 102) be allowed. In some examples, reverse current is enabled by the current source 112, which is coupled between the second terminal of the transistor 108 and the reference terminal to cause a portion of IREF2 to bypass the voltage-to-current converter 118, and require an increase in IREF2 to compensate for the current flowing through the current source 112.

In some switching converters, the current source 112 is disabled (no current flows through the current source 112) in PFM and enabled in FPWM. Enabling the current source 112 when transitioning from PFM operation to FPWM operation causes a reduction in inductor current, which causes the voltage at VOUT to drop. This transient voltage drop is undesirable in some applications. The switching converter 100 includes circuitry that reduces or prevents the transient on VOUT when transitioning from PFM to FPWM.

In the switching converter 100, the current I_{L} flowing through the transistor 102 can be expressed as:

$${I}_{L} = {K}_{s n s} ( {I}_{r e f} - \frac{R}{{R}_{s n s}} {I}_{offset} )$$

where:
the ratio of size of the transistor 104 to the size of the transistor 102 is 1:Kₛₙₛ;
Iref is the current flowing through the transistor 104 and the transistor 108 (IREF1=IREF2);
R is the resistance of the transistor 106;
Rₛₙₛ is the resistance of the transistor 104; and
I_{offset} is the current flowing through the current source 112.

In the switching converter 100, the current source 114 and the current source 116 are coupled to the voltage-to-current converter 118 to provide currents that allow the current source 112 to remain enabled in FPWM and PFM, while no reverse current flows in PFM. The current source 114 has an input coupled to a voltage terminal (AVDD), and an output coupled to a fourth input of the voltage-to-current converter 118 via the switch 142. The switch 142 has a first terminal coupled to the output of the current source 114, a second terminal coupled to the fourth input of the voltage-to-current converter 118, and a control input coupled to an output of the modulation controller 122 for receipt of the control signal F̅P̅W̅M̅. If F̅P̅W̅M̅ has a logic high state, indicating that the 100 is operating in PFM, then the switch 142 is closed, and I_{CLMP_COMP} flows from the current source 114 to the voltage-to-current converter 118. If F̅P̅W̅M̅ has a logic low state, indicating that the 100 is operating in PFM, then the switch 142 is open, and I_{CLMP_COMP} flows from the current source 114 to the voltage-to-current converter 118. The current source 116 has an input coupled to AVDD, and an output coupled to a fifth input of the voltage-to-current converter 118.

To avoid reverse current in PFM, the switching converter 100 clamps Iref (e.g., IREF1 and IREF2) to the current I_{CLMP} provided by the current source 116. The minimum inductor current controllable by the switching converter 100 (by the compensation signal COMP) may be expressed as:

$${I}_{sns \_ clmp} = {K}_{s n s} ( {I}_{CLMP} + {I}_{CLMP \_ COMP} - \frac{R}{{R}_{s n s}} {I}_{offset} )$$

where:
I_{CLMP} is the current provided by the current source 116; and
I_{CLMP_COMP} is the current provided by the current source 114.

In the switching converter 100, the current source 114 provides I_{CLMP_COMP} such that I_{sns_clmp}>0 to prevent reverse current flow in PFM. Accordingly, the switching converter 100 avoids reverse current flow in PFM, even though the current source 112 is enabled.

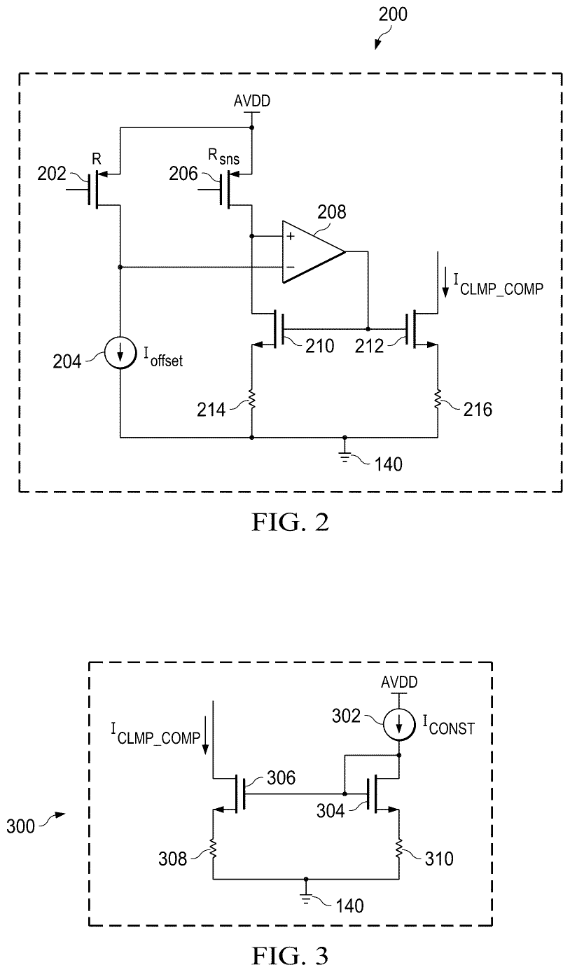

FIG. 2 is a schematic diagram of a clamp compensation current source 200 suitable for use in the switching converter 100. The clamp compensation current source 200 is an example of the current source 114. The clamp compensation current source 200 includes transistors 202, 206, 210, and 212, a current source 204, an amplifier 208, and resistors 214 and 216. The transistors 202 and 206 are PFETs selected to the same sizes as the transistors 106 and 104, respectively. The transistors 210 and 212 may be NFETs. The current source 204 may conduct the same current (I_{offset}) as the current source 112. The transistor 202 has a first terminal (e.g., source) coupled to a voltage terminal (AVDD), a second terminal (e.g., drain) coupled to the current source 204, and a control terminal (e.g., gate) coupled to the reference terminal (e.g., ground 140) or other bias voltage circuit. The current source 204 has an input coupled to the second terminal of the transistor 202, and an output coupled to the reference terminal.

The transistor 206 has a first terminal (e.g., source) coupled to the first terminal of the transistor 202, a second terminal (e.g., drain) coupled to the amplifier 208, and a control terminal (e.g., gate) coupled to the reference terminal or other bias voltage circuit. The transistor 210 has a first terminal (e.g., drain) coupled to the second terminal of the transistor 206, a second terminal (e.g., source) coupled to the reference terminal via the resistor 214, and a control terminal (e.g., gate) coupled to the amplifier 208. The transistor 212 has a first terminal (e.g., drain) coupled to the fourth input of the voltage-to-current converter 118, a second terminal (e.g., source) coupled to the reference terminal via the resistor 216, and a control terminal (e.g., gate) coupled to the control terminal of the transistor 210.

The amplifier 208 has a first input coupled to the second terminal of the transistor 206, a second input coupled to the second terminal of the transistor 202, and an output coupled to the control terminal of the transistor 210. The amplifier 208 generates an error signal based on the difference between the voltage at the second terminal of the transistor 202 and the voltage at the second terminal of the transistor 206 and provides the error signal to control the transistor 210 and the transistor 212. Responsive to the error signal, the transistor 210 adjusts the voltage at the second terminal of the transistor 206 to equal the voltage at the second terminal of the transistor 202, and adjusts the current flow through the transistor 212. Accordingly, the amplifier 208 can vary the error signal controlling the transistor 212 to maintain I_{CLMP_COMP} over temperature changes affecting the transistor 104, the transistor 106, and the current source 112.

FIG. 3 is a schematic diagram of a clamp compensation current source 300 suitable for use in the switching converter 100. The clamp compensation current source 300 is an example of the current source 114. The clamp compensation current source 300 includes transistors 304 and 306, a current source 302, and resistors 308 and 310. The transistor 304 and the transistor 306 may be NFETs. The transistor 304 has a first terminal (e.g., drain) coupled to the current source 302, a second terminal (e.g., source) coupled to the reference terminal via the resistor 310, and a control terminal (e.g., gate) coupled to the first terminal of the transistor 304. The current source 302 provides a constant current, and has an input coupled to AVDD and an output coupled to the first terminal of the transistor 304. The transistor 306 has a first terminal (e.g., drain) coupled to the fourth input of the voltage-to-current converter 118, a second terminal (e.g., source) coupled to the reference terminal via the resistor 308, and a control terminal (e.g., gate) coupled to the control terminal of the transistor 304. Accordingly, while the clamp compensation current source 300 is less complex than the clamp compensation current source 200, I_{CLMP_COMP} provided by the clamp compensation current source 300 may exhibit temperature-based variation not present with the clamp compensation current source 200.

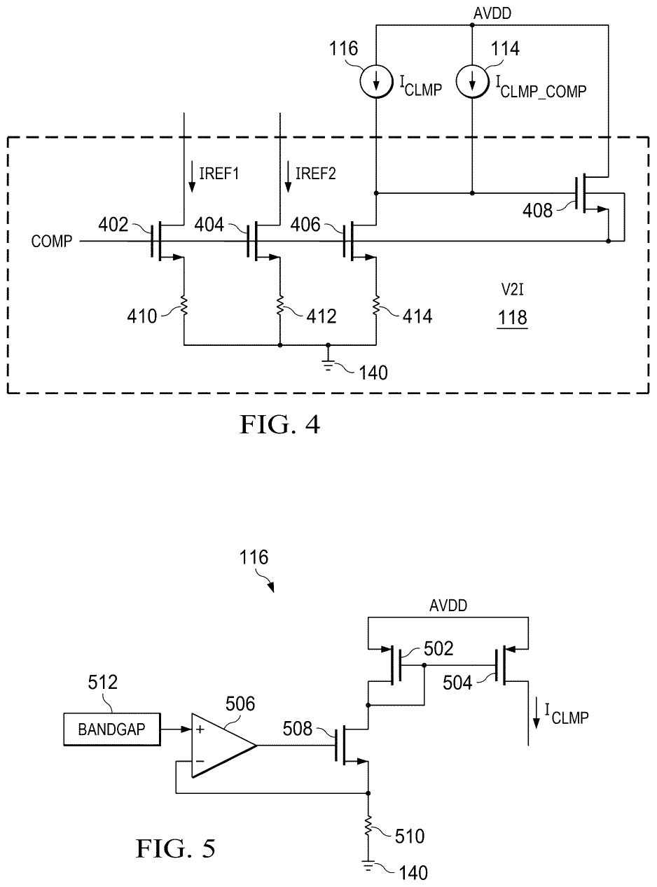

FIG. 4 is a schematic diagram of an example voltage-to-current converter 118 suitable for use in the switching converter 100. The voltage-to-current converter 118 includes transistors 402, 404, 406, and 408, and resistors 410, 412, and 414. The transistors 402, 404, 406, and 408 may be NFETs. The transistor 402 has a first terminal (e.g., drain) coupled to the second terminal of the transistor 106, a second terminal coupled to the reference terminal via the resistor 410, and a control terminal (e.g., gate) coupled to the output of the amplifier 110. The transistor 402 conducts current from IREF1 responsive to COMP. The transistor 404 has a first terminal (e.g., drain) coupled to the second terminal of the transistor 108, a second terminal coupled to the reference terminal via the resistor 412, and a control terminal (e.g., gate) coupled to the control terminal of the transistor 402. The transistor 404 conducts current from IREF2 responsive to COMP. The transistor 406 has a first terminal (e.g., drain) coupled to the output of the current source 116 and the output of the current source 114, a second terminal (e.g., source) coupled to the reference terminal via the resistor 414, and a control terminal (e.g., gate) coupled to the control terminal of the transistor 402. The transistor 406 conducts current from ICLMP and ICLMP_COMP responsive to COMP. The transistor 408 has a first terminal (e.g., drain) coupled to AVDD, a second terminal (e.g., source) coupled to the control terminal of the transistor 402, and a control terminal (e.g., gate) coupled to the first terminal of the transistor 406. The transistor 406 conducts current from AVDD to COMP responsive to ICLMP and ICLMP_COMP. Accordingly, the voltage-to-current converter 118 can clamp COMP based on the currents provided by the current sources 116 and 114.

FIG. 5 is a schematic diagram of an example current source 116 suitable for use in the switching converter 100. The current source 116 includes transistors 502, 504, and 508, an amplifier 506, a resistor 510, and a bandgap circuit 512. The transistor 502 and the transistor 504 may be PFETs. The transistor 508 may be an NFET. The transistor 502 has a first terminal (e.g., source) coupled to AVDD, a second terminal (e.g., drain) coupled to the transistor 508, and a control terminal (e.g., gate) coupled to the second terminal of the transistor 502. The transistor 504 has a first terminal (e.g., source) coupled to the first terminal of the transistor 502, a second terminal coupled to the fifth input of the voltage-to-current converter 118, and a control terminal (e.g., gate) coupled to the control terminal of the transistor 502. ICLMP is provided at the second terminal of the transistor 504.

The transistor 508 has a first terminal coupled to the second terminal of the transistor 502, a second terminal (e.g., source) coupled to the reference terminal via the resistor 510, and a control terminal (e.g., gate) coupled to the amplifier 506. The amplifier 506 has a first input coupled to a bandgap circuit 512 (or a bandgap terminal at which a bandgap voltage is provided), a second input coupled to the second terminal of the transistor 508, and an output coupled to the control terminal of the transistor 508. The amplifier 506 causes the transistor 508 to draw a current that provides a voltage across the resistor 510 that is equal to the voltage provided by the bandgap circuit 512. A scaled version of the current flowing through the transistor 502 flows through the transistor 504 (1:10 scaled in the example of FIG. 5) as ICLMP.

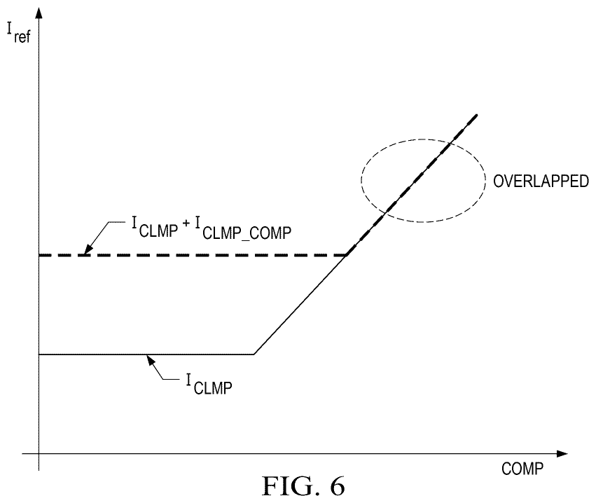

FIG. 6 is a graph of example reference current clamping in the switching converter 100. In FIG. 6, the x-axis is COMP voltage, and the y-axis is Iref current. FIG. 6 shows the clamping of Iref with I_{CLMP} alone, and with I_{CLMP}+I_{CLMP_COMP}. If the switching converter 100 is operating in FPWM mode, then I_{CLMP_COMP} is not provided, and Iref is clamped based on I_{CLMP}. If the switching converter 100 is operating in PFM mode, then I_{CLMP_COMP} is provided from the current source 114. In PFM, as Iref current drops towards zero (with reduction of current flow from the inductor 138), I_{CLMP}+I_{CLMP_COMP} clamps Iref at a higher current value than I_{CLMP} alone to prevent reverse current flow through the transistor 102. Accordingly, the clamping provided by the 100 allows the current source 112 to remain enabled in PFM, and transients caused by switching the current source 112 into or out of the circuit can be avoided.

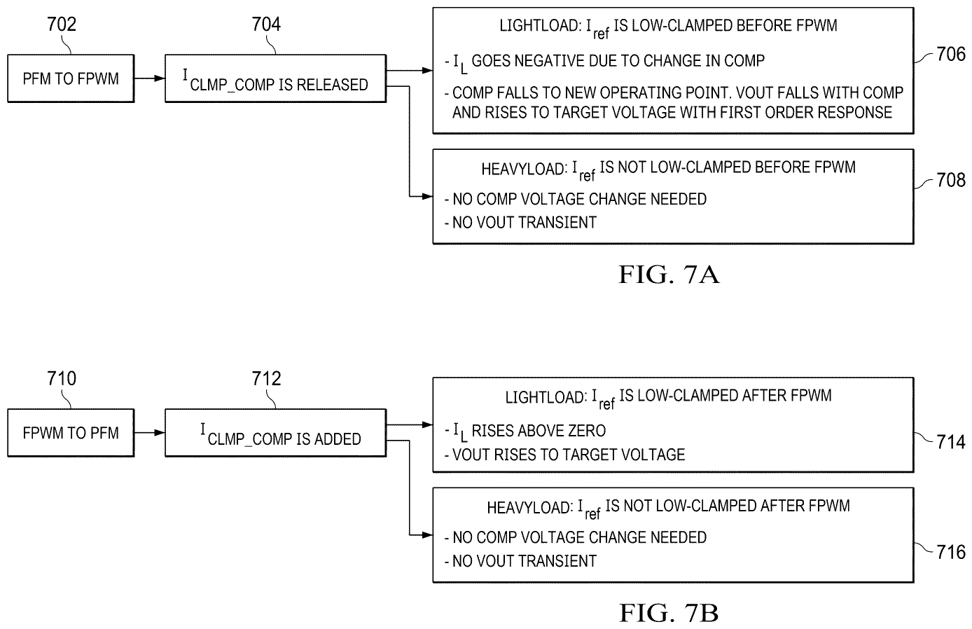

FIG. 7A is a flow diagram describing transition from PFM to FPWM in the switching converter 100 as described in block 702. In block 704, I_{CLMP_COMP} is released. That is, reference current is not clamped to I_{CLMP}+I_{CLMP_COMP}. If the switching converter 100 is operating under light load conditions, then in block 706, Iref is low-clamped to I_{CLMP}+I_{CLMP_COMP} before the switching converter 100 transitions to FPWM operation to prevent negative current in PFM. As the switching converter 100 transitions to from PFM to FPWM, the COMP voltage begins to fall to establish a new operating point. VOUT may fall slightly below the targe voltage, then rise to the target voltage with a first order response. Light load conditions may refer to conditions under which the switching converter 100 may not switch continuously to provide an output voltage higher than the target voltage. In some examples, a load drawing less than 300 milliamperes (ma) may be considered a light load.

If the switching converter 100 is operating under heavy load conditions, then in block 708, Iref is not clamped to I_{CLMP}+I_{CLMP_COMP} before the switching converter 100 transitions to FPWM. No changes in the COMP voltage are needed, and no transients are generated on VOUT. Heavy load conditions may refer to conditions under which the switching converter 100 may switch continuously to provide the target voltage. In some examples a load drawing more than 300 ma may be considered a heavy load.

FIG. 7B is a flow diagram describing transition for FPWM to PFM in the switching converter 100 as described in block 710. In block 712, I_{CLMP_COMP} is added. That is, reference current is clamped to I_{CLMP}+I_{CLMP_COMP} after the transition to PFM. If the switching converter 100 is operating under light load conditions, then in block 714, Iref is clamped to I_{CLMP}+I_{CLMP_COMP} after the switching converter 100 transitions out of FPWM operation to prevent negative current in PFM. As the switching converter 100 transitions from FPWM to PFM, VOUT rises to the target voltage.

If the switching converter 100 is operating under heavy load conditions, then in block 716, Iref is not clamped to I_{CLMP}+I_{CLMP_COMP} after the transition from FPWM to PFM. No changes in the COMP voltage are needed, and no transients are generated on VOUT.

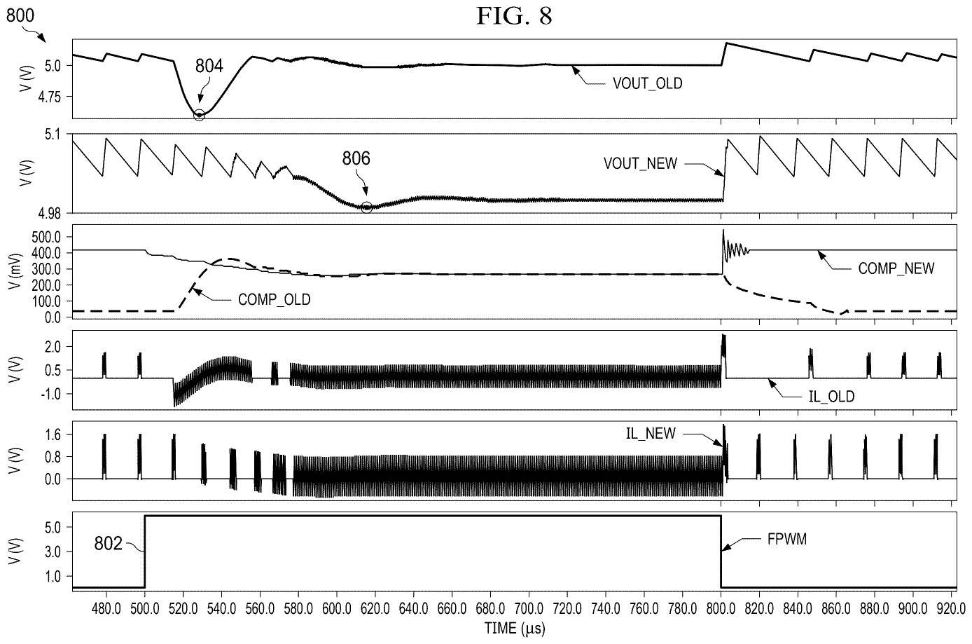

FIG. 8 is a graph 800 of example signals in the switching converter 100 showing transitions between PFM and FPWM under light load conditions. The graph 800 shows signals FPWM, IL_NEW, IL_OLD, COMP_NEW, COMP_OLD, VOUT_NEW, and VOUT_OLD. IL_NEW, COMP_NEW, and VOUT_NEW are inductor current, COMP voltage, and output voltage in the switching converter 100. IL_OLD, COMP_OLD, and VOUT_OLD are inductor current, COMP voltage, and output voltage in a switching converter similar to the switching converter 100 that disables the current source 112 in PFM (hereafter referred to as the “conventional converter”).

At about time 802, the FPWM signal triggers transition from PFM to FPWM. Transitioning from PFM to FPWM causes the conventional converter to enable the current source 112, which sinks reference current and causes the transient 804 on VOUT_OLD. In the switching converter 100, the current source 112 is enabled in both PFM and FPWM. VOUT_NEW drops slightly below the target voltage (5 volts in FIG. 8) at time 806, and rises to the target voltage with a first order response. Accordingly, the switching converter 100 significantly reduces output voltage transients when changing from PFM to FPWM.

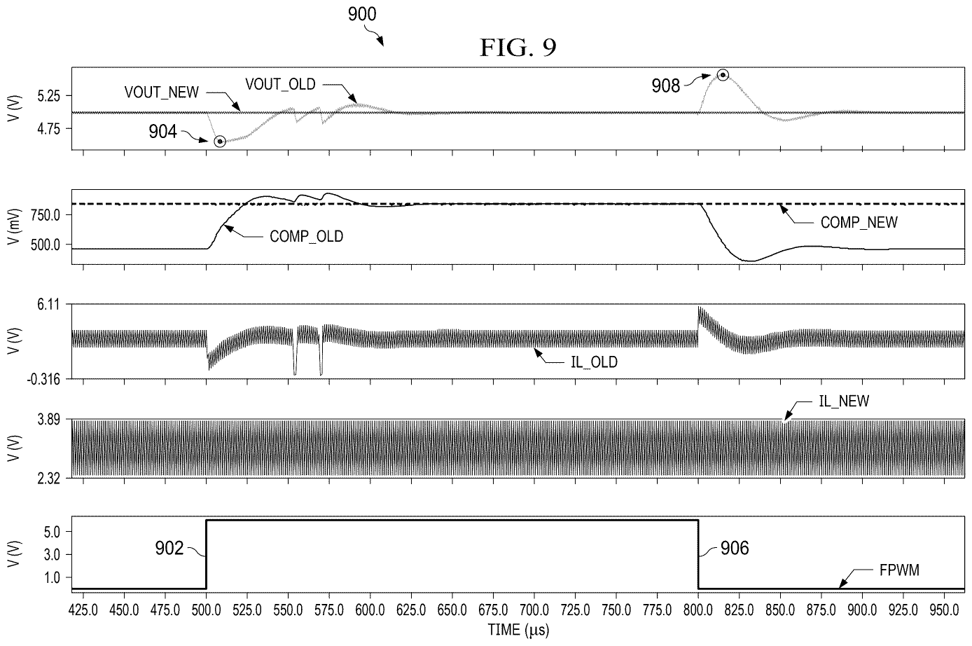

FIG. 9 is a graph 900 of example signals in the switching converter 100 showing transitions between PFM and FPWM under heavy load conditions. The graph 900 shows signals FPWM, IL_NEW, IL_OLD, COMP_NEW, COMP_OLD, VOUT_NEW, and VOUT_OLD. IL_NEW, COMP_NEW, and VOUT_NEW are inductor current, COMP voltage, and output voltage in the switching converter 100. IL_OLD, COMP_OLD, and VOUT_OLD are inductor current, COMP voltage, and output voltage in a switching converter similar to the switching converter 100 that disables the current source 112 in PFM (hereafter referred to as the “conventional converter”).

At about time 902, the FPWM signal triggers transition from PFM to FPWM. Transitioning from PFM to FPWM causes the conventional converter to enable the current source 112, which sinks reference current and causes the transient 904 on VOUT_OLD. In the switching converter 100, the current source 112 is enabled in both PFM and FPWM, and no transient is present on VOUT_NEW.

At about time 906, the FPWM signal triggers transition from FPWM to PFM. Transitioning from FPWM to PFM causes the conventional converter to disable the current source 112, reference current increases and causes the transient 908 on VOUT_OLD. In the switching converter 100, the current source 112 is enabled in both PFM and FPWM, and no transient is present on VOUT_NEW. Accordingly, the switching converter 100 significantly reduces output voltage transients when changing from PFM to FPWM.

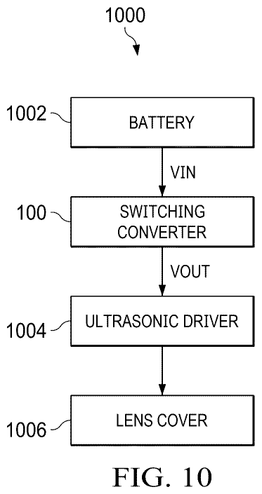

FIG. 10 is a block diagram of an example ultrasonic lens cleaning system 1000. The ultrasonic lens cleaning system 1000 includes a battery 1002, the switching converter 100, an ultrasonic driver 1004, and a lens cover 1006. The battery 1002 is voltage source that provides a voltage for powering the ultrasonic driver 1004 via the switching converter 100. Other types of voltage sources may also be used in lieu of the battery 1002. The battery 1002 has an output at which voltage VIN is provided. The output of the battery 1002 is coupled to an input of the switching converter 100. The switching converter 100 generates the output voltage VOUT, and can operate in multiple modulation modes as described herein. The switching converter 100 reduces or eliminates transients on VOUT when transitioning between modulations modes. The switching converter 100 provides this advantage by enabling the current source 112 in PFM and FPWM, while preventing reverse current flow in PFM.

The ultrasonic driver 1004 has a voltage input for receiving the output voltage VOUT, where VOUT powers ultrasonic driver circuitry that generates a drive signal. The ultrasonic driver 1004 is coupled to the lens cover 1006. The lens cover 1006 includes ultrasonic transducer, e.g., a piezoelectric transducer, which receives the drive signal and generates acoustic waves that can be used to clean a lens or lens cover.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

As used herein, the terms “terminal,” “node,” “interconnection,” “pin” and “lead” are used interchangeably. Unless specifically stated to the contrary, these terms are generally used to mean an interconnection between or a terminus of a device element, a circuit element, an integrated circuit, a device or other electronics or semiconductor component.

A circuit or device that is described herein as including certain components may instead be adapted to be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be adapted to be coupled to at least some of the passive elements and/or the sources to form the described structure either at a time of manufacture or after a time of manufacture, for example, by an end-user and/or a third-party.

While the use of particular transistors is described herein, other transistors (or equivalent devices) may be used instead with little or no change to the remaining circuitry. For example, a field effect transistor (“FET”) (such as an n-channel FET (NFET) (n-type transistor) or a p-channel FET (PFET)) (p-type transistor)), a bipolar junction transistor (BJT—e.g., NPN transistor or PNP transistor), an insulated gate bipolar transistor (IGBT), and/or a junction field effect transistor (JFET) may be used in place of or in conjunction with the devices described herein. The transistors may be depletion mode devices, drain-extended devices, enhancement mode devices, natural transistors, or other types of device structure transistors. Furthermore, the devices may be implemented in/over a silicon substrate (Si), a silicon carbide substrate (SIC), a gallium nitride substrate (GaN) or a gallium arsenide substrate (GaAs).

References may be made in the claims to a transistor's control input and its current terminals. In the context of a FET, the control input (or transistor control terminal) is the gate, and the current terminals are the drain and source. In the context of a BJT, the control input is the base, and the current terminals are the collector and emitter.

References herein to a FET being “ON” means that the conduction channel of the FET is present and drain current may flow through the FET. References herein to a FET being “OFF” means that the conduction channel is not present so drain current does not flow through the FET. An “OFF” FET, however, may have current flowing through the transistor's body-diode.

Circuits described herein are reconfigurable to include additional or different components to provide functionality at least partially similar to functionality available prior to the component replacement. Components shown as resistors, unless otherwise stated, are generally representative of any one or more elements coupled in series and/or parallel to provide an amount of impedance represented by the resistor shown. For example, a resistor or capacitor shown and described herein as a single component may instead be multiple resistors or capacitors, respectively, coupled in parallel between the same nodes. For example, a resistor or capacitor shown and described herein as a single component may instead be multiple resistors or capacitors, respectively, coupled in series between the same two nodes as the single resistor or capacitor.

While certain elements of the described examples are included in an integrated circuit and other elements are external to the integrated circuit, in other example embodiments, additional or fewer features may be incorporated into the integrated circuit. In addition, some or all of the features illustrated as being external to the integrated circuit may be included in the integrated circuit and/or some features illustrated as being internal to the integrated circuit may be incorporated outside of the integrated. As used herein, the term “integrated circuit” means one or more circuits that are: (i) incorporated in/over a semiconductor substrate; (ii) incorporated in a single semiconductor package; (iii) incorporated into the same module; and/or (iv) incorporated in/on the same printed circuit board.

Uses of the phrase “ground” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter or, if the parameter is zero, a reasonable range of values around zero.

Modifications are possible in the described embodiments, and other embodiments are possible, within the scope of the claims.

What is claimed is:

1. A circuit comprising:
a first transistor having a first terminal, a second terminal, and a control terminal;
a second transistor having a first terminal coupled to the first terminal of the first transistor, a second terminal, and a control terminal coupled to the control terminal of the first transistor;
a third transistor having a first terminal coupled to the second terminal of the second transistor, a second terminal, and a control terminal;
a fourth transistor having a first terminal coupled to the second terminal of the first transistor, a second terminal, and a control terminal coupled to the control terminal of the third transistor;
an amplifier having a first input coupled to a reference voltage terminal, a second input coupled to the second terminal of the first transistor, and an output;
a voltage-to-current converter having a first input coupled to the second terminal of the third transistor, a second input coupled to the second terminal of the fourth transistor, a third terminal coupled to the output of the amplifier, a fourth input, and a fifth input;
a first current source having an input coupled to the second terminal of the fourth transistor, and an output coupled to a reference terminal;
a second current source having an input coupled to a power terminal, and an output coupled to the fourth input of the voltage-to-current converter; and
a third current source having an input coupled to the input of the second current source, and an output coupled to the fifth input of the voltage-to-current converter.

2. The circuit of claim 1, wherein the voltage-to-current converter includes:
a fifth transistor having a first terminal coupled to the power terminal, a second terminal coupled to the output of the amplifier, and a control terminal coupled to the output of the second current source and the output of the third current source.

3. The circuit of claim 2, wherein the voltage-to-current converter includes: a sixth transistor having a first terminal coupled to the control terminal of the fifth transistor, a second terminal coupled to the reference terminal, and a control terminal coupled to the output of the amplifier.

4. The circuit of claim 2, wherein the voltage-to-current converter includes:
a sixth transistor having a first terminal coupled to the second terminal of the third transistor, a second terminal coupled to the reference terminal, and a control terminal coupled to the output of the amplifier; and
a seventh transistor having a first terminal coupled to the second terminal of the fourth transistor, a second terminal coupled to the reference terminal, and a control terminal coupled to the output of the amplifier.

5. The circuit of claim 1, wherein the second current source includes:
a fifth transistor having a first terminal coupled to a power terminal, a second terminal, and a control terminal coupled to the reference terminal;
a sixth transistor having a first terminal coupled to the power terminal, a second terminal, and a control terminal coupled to the reference terminal;
a fourth current source having an input coupled to the second terminal of the fifth transistor, and an output coupled to the reference terminal;
an amplifier having a first input coupled to the second terminal of the fifth transistor, a second input coupled to the second terminal of the sixth transistor, and an output;
a seventh transistor having a first terminal coupled to the second terminal of the sixth transistor, a second terminal coupled to the reference terminal, and a control terminal coupled to the output of the amplifier; and
an eighth transistor having a first terminal coupled to the fourth input of the voltage-to-current converter, a second terminal coupled to the reference terminal, and a control terminal coupled to the control terminal of the seventh transistor.

6. The circuit of claim 1, wherein the second current source includes:
a fourth current source having an input coupled to a power terminal, and an output;
a fifth transistor having a first terminal coupled to the output of the fourth current source, a second terminal coupled to the reference terminal, and a control terminal coupled to the output of the fourth current source; and
a sixth transistor having a first terminal coupled to fifth input of the voltage-to-current converter, a second terminal coupled to the reference terminal, and a control terminal coupled to the control terminal of the fifth transistor.

7. The circuit of claim 1, wherein the third current source includes:
a fifth transistor having a first terminal coupled to a power terminal, a second terminal, and a control terminal coupled to the second terminal of the fifth transistor;
a sixth transistor having a first terminal coupled to the power terminal, a second termina coupled to the fifth input of the voltage-to-current converter, and a control terminal coupled to the control terminal of the fifth transistor;
a seventh transistor having a first terminal coupled to the second terminal of the first transistor, a second terminal, and a control terminal; and
an amplifier having a first input coupled to a bandgap terminal, a second input coupled to the second terminal of the seventh transistor, and an output coupled to the control terminal of the seventh transistor.

8. A circuit comprising:
a first transistor having a first terminal, a second terminal, and a control terminal;
a second transistor having a first terminal coupled to the first terminal of the first transistor, a second terminal, and a control terminal coupled to the control terminal of the first transistor;
a third transistor having a first terminal coupled to the second terminal of the second transistor, a second terminal, and a control terminal;
a fourth transistor having first terminal coupled to the second terminal of the first transistor, a second terminal, and a control terminal coupled to the control terminal of the third transistor;
a first amplifier having a first input coupled to a reference voltage terminal, a second input coupled to the second terminal of the first transistor, and an output;
a voltage-to-current converter having a first input coupled to the second terminal of the third transistor, a second input coupled to the second terminal of the fourth transistor, a third input coupled to the output of the first amplifier, a fourth input, and a fifth input; and
a first current source having an input coupled to a power terminal, and an output coupled to the fourth input of the voltage-to-current converter; and
a second current source including:
a fifth transistor having a first terminal coupled to a power terminal, a second terminal, and a control terminal coupled to a reference terminal;
a sixth transistor having a first terminal coupled to the power terminal, a second terminal, and a control terminal coupled to the reference terminal;
a third current source having an input coupled to the second terminal of the fifth transistor, and an output coupled to the reference terminal;
a second amplifier having a first input coupled to the second terminal of the fifth transistor, a second input coupled to the second terminal of the sixth transistor, and an output;
a seventh transistor having a first terminal coupled to the second terminal of the sixth transistor, a second terminal coupled to the reference terminal, and a control terminal coupled to the output of the second amplifier; and
an eighth transistor having a first terminal coupled to the fifth input of the voltage-to-current converter, a second terminal coupled to the reference terminal, and a control terminal coupled to the control terminal of the seventh transistor.

9. The circuit of claim 8, further comprising a fourth current source having an input coupled to the second terminal of the fourth transistor, and an output coupled to the reference terminal.

10. The circuit of claim 8, wherein the voltage-to-current converter includes:
a ninth transistor having a first terminal coupled to the power terminal, a second terminal coupled to the output of the first amplifier, and a control terminal coupled to the output of the second current source and the output of the third current source.

11. The circuit of claim 10, wherein the voltage-to-current converter includes:
a tenth transistor having a first terminal coupled to the control terminal of the ninth transistor, a second terminal coupled to the reference terminal, and a control terminal coupled to the output of the first amplifier.

12. The circuit of claim 10, wherein the voltage-to-current converter includes:
a tenth transistor having a first terminal coupled to the second terminal of the third transistor, a second terminal coupled to the reference terminal, and a control terminal coupled to the output of the first amplifier; and
an eleventh transistor having a first terminal coupled to the second terminal of the fourth transistor, a second terminal coupled to the reference terminal, and a control terminal coupled to the output of the first amplifier.

13. The circuit of claim 8, wherein the first current source includes:
a ninth transistor having a first terminal coupled to a power terminal, a second terminal, and a control terminal coupled to the second terminal of the fifth transistor;
a tenth transistor having a first terminal coupled to the power terminal, a second terminal coupled to the fifth input of the voltage-to-current converter, and a control terminal coupled to the control terminal of the fifth transistor;
an eleventh transistor having a first terminal coupled to the second terminal of the first transistor, a second terminal, and a control terminal; and
a third amplifier having a first input coupled to a bandgap terminal, a second input coupled to the second terminal of the seventh transistor, and an output coupled to the control terminal of the eleventh transistor.

14. The circuit of claim 8, further comprising a comparator having a first input coupled to the second terminal of the third transistor, a second input coupled to the second terminal of the fourth transistor, and an output coupled to a modulation controller.

15. A system, comprising:
a switching converter, comprising:
a low-side transistor having a first terminal coupled to a voltage terminal, a second terminal coupled to a reference terminal, and a control terminal;
a high-side transistor having a first terminal coupled to the voltage terminal, a second terminal, and a control terminal;
a sense transistor having a first terminal coupled to the first terminal of the high-side transistor, a second terminal, and a control terminal coupled to the control terminal of the high-side transistor, the sense transistor configured to conduct a sense current representative of a current flowing through the high-side transistor;
a voltage-to-current converter having first, second, third, fourth, and fifth inputs;
a first transistor coupled between the second terminal of the sense transistor and the first input of the voltage-to-current converter, the first transistor configured to conduct the sense current;
a second transistor coupled between the second terminal of the high-side transistor and the second input of the voltage-to-current converter;
a comparator having a first input coupled to the second terminal of the first transistor, a second input coupled to the second terminal of the second transistor, and an output;
an error amplifier having a first input coupled to the second terminal of the high-side transistor, a second input coupled to a reference voltage terminal, and an output coupled to the third input of the voltage-to-current converter;
a controller having a first output coupled to the control terminal of the low-side transistor, a second output coupled to the control terminal of the high-side transistor, and an input coupled to the output of the comparator, the controller configured to drive the high-side transistor in a first mode and a second mode; and
a current source coupled between the second terminal of the second transistor and the reference terminal, the current source configured to draw a current from the second transistor in the first mode and the second mode.

16. The system of claim 15, further comprising:
an ultrasonic driver having a voltage input coupled to the second terminal of the high-side transistor and an output; and
a lens cover having an input coupled to the output of the ultrasonic driver.

17. The system of claim 15, wherein the switching converter includes:
a clamp current source having an output coupled to the fourth input of the voltage-to-current converter; and
a clamp compensation current source having an output coupled to the fifth input of the voltage-to-current converter.

18. The system of claim 17, wherein the clamp compensation current source includes:
a third transistor having a first terminal coupled to a power terminal, a second terminal, and a control terminal coupled to the reference terminal;
a fourth transistor having a first terminal coupled to the power terminal, a second terminal, and a control terminal coupled to the reference terminal;
a fourth current source having an input coupled to the second terminal of the third transistor, and an output coupled to the reference terminal;
an amplifier having a first input coupled to the second terminal of the third transistor, a second input coupled to the second terminal of the fourth transistor, and an output;
a fifth transistor having a first terminal coupled to the second terminal of the fourth transistor, a second terminal coupled to the reference terminal, and a control terminal coupled to the output of the amplifier; and
a sixth transistor having a first terminal coupled to the fifth input of the voltage-to-current converter, a second terminal coupled to the reference terminal, and a control terminal coupled to the control terminal of the fifth transistor.

19. The system of claim 17, wherein the voltage-to-current converter includes:
a third transistor having a first terminal coupled to a power terminal, a second terminal coupled to the output of the error amplifier, and a control terminal coupled to the output of the clamp current source and the output of the clamp compensation current source; and
a fourth transistor having a first terminal coupled to the control terminal of the third transistor, a second terminal coupled to the reference terminal, and a control terminal coupled to the output of the error amplifier.

20. The system of claim 19, wherein the voltage-to-current converter includes:
a fifth transistor having a first terminal coupled to the second terminal of the first transistor, a second terminal coupled to the reference terminal, and a control terminal coupled to the output of the error amplifier; and
a sixth transistor having a first terminal coupled to the second terminal of the second transistor, a second terminal coupled to the reference terminal, and a control terminal coupled to the output of the error amplifier.
